(19) United States
(12) Patent Application Publication
(10) Pub. No.: US 2005/0210862 A1
(43) Pub. Date: Sep. 29, 2005

(54) Quantum jet turbine propulsion system

(76) Inventor: Von Friedrich C. Paterro, Makati City (PH)

Correspondence Address: OLIFF & BERRIDGE, PLC, P.O. BOX 19928, ALEXANDRIA, VA, 22320, US

(21) Appl. No.: 10/808,371

(22) Filed: Mar. 25, 2004

(51) Int. Cl. F02K 3/00

(52) U.S. Cl. 60/224

(57) ABSTRACT

A quantum jet turbine propulsion system includes a plurality of jet turbine engines housed within an airtight common exhaust system. The individual jet turbine engines receive propulsion from fuel and air sources remote from the engines, preferably provided by fuel and air pumps and air compressors. The jet turbine propulsion system includes its own turbine driven generator as a self-generating power source, and achieves increased efficiencies through the use of a specially adapted exhaust housing configuration. The jet turbine propulsion system is suitable for use in all forms of land, sea, air and space vehicles. Although many propulsion sources can be used, a preferred propulsion source is a mixture of water and air.

### BACKGROUND OF THE INVENTION

1. Field of Invention

This invention relates to a modified jet engine for use in various land vehicles, sea craft, or flying craft that is housed within a sealed exhaust system and augmented by powerful compressors and air and fuel pumps to deliver oxygen and fuel needs to achieve improved energy efficiency, fuel economy, safety and versatility.

2. Description of Related Art

Numerous land vehicles, flying craft and sea craft utilize solid, gas or liquid fossil fuels in jet or rocket engines to provide thrust for propulsion of the craft/vehicle. While many improvements have been made over the years, the main focus in further efficiency has been in the engine design, with much energy still being wasted or needlessly expelled out of the exhaust of such conventional engine exhaust systems.

There is a need for an efficient, economical, safe and versatile jet or rocket engine that can minimize wasted fuel.

Other problems with conventional jet engines are the conventional requirement for an open-mouth intake system in which incoming air enters the jet directly from the atmosphere. Occasionally, objects are sucked into such jet engines where they can damage or completely render inoperable several components of the jet engine. As such, there is a need for an improved jet turbine system that locates an air source remote from the jet turbine itself.

There also is a need for a jet turbine system that can operate using a multitude of different fuel sources, particularly environmentally friendly sources such as air and water.

### SUMMARY OF THE INVENTION

Applicant has overcome various long felt needs by providing a novel quantum jet turbine system that is housed within an airtight exhaust system. One or more jet turbine engines can share one common exhaust system depending on the size and design of the fuselage and its application. This sealed type quantum jet engine puts to an end the numerous problems associated with conventional jet engine design, since by having the quantum jet engine sealed and housed within one exhaust system, the engine can prevent entry of foreign objects. With this design, independent fuel and compressed air supplies are fed to the sealed jet turbines through sealed feed lines. Moreover, by elimination of an integral open atmosphere intake, the jet is readily adaptable to rocket use for space travel when coupled with a self-contained source of oxygen, such as a liquid or compressed oxygen or air storage tank. Thus, a craft with a quantum jet turbine can fly or land anywhere, including in the presence of flocks of birds, insects, mammals, or dust, while keeping out such foreign objects. Moreover, the system is adaptable to atmospheric, stratospheric or space flight.

By coupling a turbine of the jet to a generator, thrust generated by the jet can be used to generate electricity to power the electrical needs of the jet engine and the craft.

By coupling the sealed quantum jet turbine to a compound exhaust system, further efficiencies are achieved by minimizing wasted fuel. That is, conventional jet and rocket engines operate by burning and directly expelling huge amounts of accelerated and expanded gases from their exhaust tubes instantly into the atmosphere, where they can do no further kinetic work. However, when coupled with an efficient exhaust system that harnesses such gases, further efficient use of the kinetic potential of the expelled gases can be realized. This reduces fuel consumption, which in turn reduces payloads by reducing the quantities of fuel needed to be stored, which also itself increases efficiencies since less mass is being propelled. A preferred compound exhaust system can be found in Applicant's U.S. Pat. No. 6,367,739, the subject matter of which is hereby incorporated herein by reference in its entirety.

Thus, whereas conventional jet and rocket engines expend about 50% or more of the volume of burnt fuels into the atmosphere with no potential to do further kinetic work, the inventive quantum jet engines, when combined with a compound exhaust, are capable of greater potential efficiency by causing the expanding gases to pass through several additional gas expansion chambers, thereby using more of the available kinetic forces from the combusting gases.

Also, while conventional rockets expel huge amounts of burnt gases at a rather low exit speed, the inventive quantum jet turbine produces kinetic energy for propulsion by expelling the gases at a much lower volume, but at a much higher velocity. Because the kinetic energy in a moving body depends on the square of its speed, it follows that harnessing ultra high speed gas molecules in a small volume and repeating the expansions through several exhaust chambers will result in a highly efficient design capable of reduced fuel consumption and comparable thrust output.

Moreover, this design incorporates quantum theory by being able to radiate energy discontinuously in quanta.

This sealed configuration also greatly reduces engine noise. Further noise reduction can be attained by use of a noise canceling device installed in the tip of the thrust vector nozzle of the exhaust.

The inventive quantum jet turbine should highly revolutionize the air and space transportation system by introducing new fuselage designs, other than conventional tubular craft, that are more adaptable and efficient in using the modified sealed jet engine designs. Such new engines are suitable for land, sea and aircraft needs, as well as spacecraft. For example, the sealed quantum jet engines which can operate without an open-mouth intake design are particularly suitable for saucer-shaped craft, such as disclosed in Applicant's U.S. Pat. No. 6,290,184, the subject matter of which is hereby incorporated herein by reference in its entirety. Such engines may also be used to power land vehicles, such as cars, trucks, vans, commercial trucks, sports cars, race cars, etc. One suitable application of such a land vehicle can be found in Applicant's co-pending U.S. application Ser. No. ______ (Attorney Docket No. 102902), the subject matter of which is hereby incorporated herein by reference in its entirety. One suitable application of such a space craft can be found in Applicant's co-pending U.S. application Ser. No. ______ (Attorney Docket No. 104148), the subject matter of which is hereby incorporated herein by reference in its entirety.

The inventive quantum jet turbine is also extremely versatile and adaptable to a multitude of possible fuel sources, such as high grade kerosene, high grade diesel fuel, alcohol, liquid hydrogen, liquid oxygen, methane, or other liquid or solid fossil fuels. It can also operate on a mixture, such as a 70/30 mix of high grade (distilled) alcohol (C2H6O), C2H50H, or CH3OH) plus distilled purified water (H₂O), which results in an efficient, safe and more environmentally friendly fuel that can be smokeless. Other applications may use a 50/50 mixture of alcohol and water, or may use 100% purified water alone (or with superchilled air) as a steam-powered version or a superchilled air version, that are completely environmentally friendly solutions that do not rely on fossil fuels.

### BRIEF DESCRIPTION OF THE DRAWINGS

The invention will be described with reference to the following drawings wherein:

FIG. 1 shows a cross-sectional view of an exemplary dual quantum jet turbine engine system housed in a common exhaust system according to the invention with various components only schematically represented;

FIG. 2 shows a cross-sectional view of a second exemplary embodiment of a dual quantum jet turbine engine system housed in a common exhaust system according to the invention with various components only schematically represented;

FIG. 3 shows an alternative embodiment of a dual quantum jet turbine engine system having an external turbine generator according to the invention;

FIG. 4 shows a further alternative embodiment of a dual quantum jet turbine engine system having an external turbine generator according to the invention; and

FIG. 5 shows an exemplary flying craft within which the inventive quantum jet turbine engine system can be effectively used.

### DETAILED DESCRIPTION OF PREFERRED EMBODIMENTS

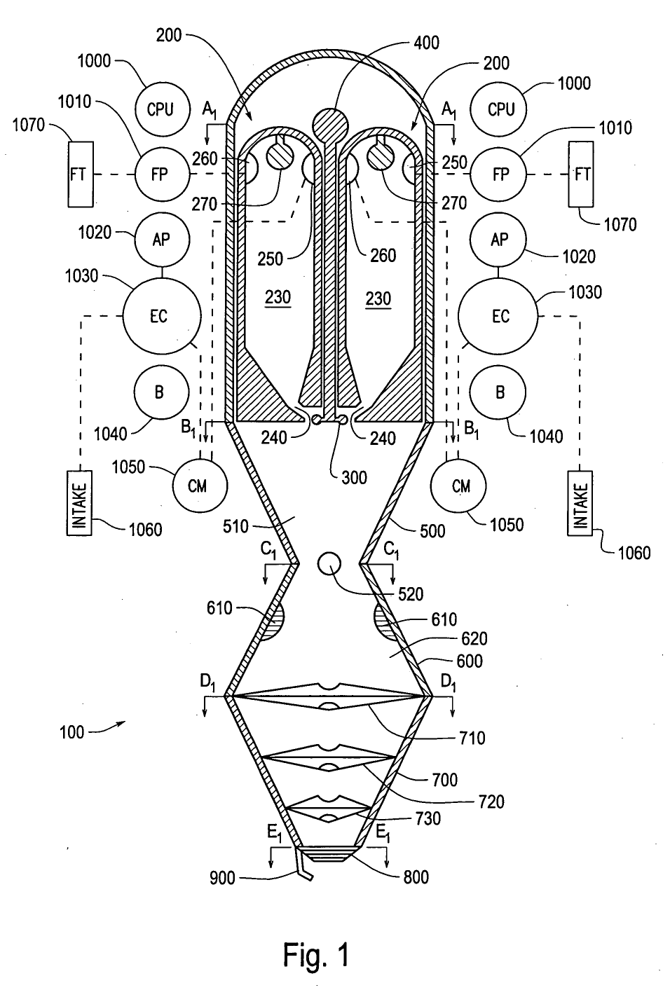

An exemplary embodiment of the invention will be described with reference to FIG. 1, which shows dual quantum jet turbine engines housed in a common air-tight sealed exhaust system. The jet engines do not take in air directly from the atmosphere as in conventional jet engines. Rather, air or oxygen are received through sealed feed lines from efficient and independent on-board air compressors on the craft or externally provided for the engines. The air compressors may receive and transfer to the quantum jet engines air/oxygen received from either a remote storage tank or a remote air intake separate from the sealed jet turbine engines. The incoming air may be filtered as desired. The incoming air may also be chilled before being pumped into the jet engines. This puts an end to the numerous problems associated with conventional jet engine designs that are prone to sucking large objects into their jet engine intakes.

Although shown as a dual engine model, the quantum jet turbine system according to exemplary embodiments of the invention can come in mono, dual, tri, quad or more jet engines commonly housed in a single air-tight sealed exhaust system. However, additional advantages are realized when more than one jet engine is provided within each exhaust system. The jet engines are suitably sized and symmetrically arranged within the exhaust system as shown, so as to provide a commonly and centrally oriented gas exhaust flow path.

In particular, FIG. 1 shows a quantum jet turbine system 100 including multiple separate quantum jet engines 200 housed within a single, common sealed exhaust system, preferably made up of sections A1, B1, C1, D1 and E1. Each quantum jet engine 200 is housed in section A1 of the exhaust system and includes an outer casing 210 having a sealed, airtight top and converging lower walls 220 defining a combustion chamber 230 therebetween. Each quantum jet engine 200 further includes a combustion exit orifice 240.

Within each combustion chamber 230 are located one or more air nozzles 250. Air nozzles 250 are operably connected to an electric air compressor 1030 through a suitable airtight, sealed feed line (unshown) sized to match the particular jet engine used. Flow from the compressor 1030 to air nozzles 250 may be enhanced by air pump 1020 provided in-line between compressor 1030 and air nozzles 250. Electric air compressors 1030 may receive air/oxygen from a suitable remote source, such as an on-board storage tank or through shown intake 1060, which is in communication with the atmosphere, but provided remote from the jet engines 200. Suitable filtering may be provided at or between the intake 1060 and electric compressors 1030 to prevent large objects from entering the system. For example, in an exemplary embodiment, air valves are located outside the fuselage of the craft on which the jet engines are installed. Air filters may be provided at the tips of the valves. The incoming air is drawn into efficient compressors 1030, which may house their own filters. Incoming air is then fed through air tubes into a chilling mechanism 1050, where the chilled air is then pumped into combustion chamber 230. As shown, the chilling mechanism 1050, air compressors 1030, air pumps 1020, and air intake 1060 are located around the periphery of the jet engine, external of the sealed exhaust system.

Also within each combustion chamber 230 are located one or more fuel nozzles 260. Fuel nozzles 260 are operably connected to an on-board fuel storage tank 1070 through a suitable airtight, sealed feedline (unshown). Flow from the tank 1070 may be enhanced by a fuel pump 1010 provided in-line between the tank 1070 and fuel nozzles 260.

A spark generator 270 is also provided within the combustion chamber 230 ofeachjet engine 200. Spark generators 270 may receive electrical power from one or more on-board batteries 1040, or from generator 400 provided within the common exhaust system. Generator 400 may be operably connected through a shaft or other structure to a turbine 300 having one or more turbine blades placed in the exit path of the combustion exit orifices 240 as shown. Upon generation of combustion gases exiting the various jet engines 200 through orifices 240, rotation of turbine 300 will occur, which can be used with known and conventional structure to generate electrical energy from generator 400. Electrical output from generator 400 may be electrically connected to batteries 1040 for recharging purposes and/or may be used to power various auxiliary devices, such as processor 1000, fuel pump 1010, air pump 1020, electric air compressors 1030, cooling mechanisms 1050 or other devices associated with the engine or craft.

During operation, quantum jet turbine engines 200 are started by activating battery power to both the air and fuel pumps 1020, 1010, respectively. Upon reaching suitable operating pressures, a desired amount of air and fuel will be fed to combustion chambers 230 while spark generators 270 are electrically activated. Upon initial ignition, processor 1000 can cut off battery current and simultaneously activate the main electric air compressors 1030, while simultaneously activating the fuel and air pumps and other electrical devices by way of current flowing from generator 400, which is suitably sized to power all required electrical devices.

The inventive quantum jet turbine system is extremely versatile and adaptable to a multitude of possible fuel sources, such as high grade kerosene, high grade diesel fuel, alcohol, liquid hydrogen, liquid oxygen, methanol, or other solid or liquid fossil fuels. It can also operate on a mixture, such as a 70/30 mix of high grade (distilled) alcohol (C2H6O, C2H50H, or CH3OH) plus distilled purified water (H₂O), which results in an efficient, safe and more environmentally friendly fuel that can be smokeless. Other applications may use a 50/50 mixture of alcohol and water. However, a most environmentally friendly solution would use 100% purified water alone or with superchilled air as a steam-powered version or a superchilled air version that does not rely on fossil fuels.

In the exemplary embodiment of FIG. 1, a possible fuel mix of 70% high grade alcohol (C2H6O) plus 30% distilled water (H₂O) is used, considering the physical properties of both compounds wherein alcohol has a low boiling point of about 375° F. (197.2° C.) and distilled water has a boiling point of 212° F. (100° C.). Both compounds should be distilled to make them more efficient in achieving faster conversion from liquid to gaseous state, due to the pure substances having no other minerals or deposits that are not combustible and could solidify and produce nozzle clogging or contamination to the combustion chamber walls 210, which can cause maintenance problems.

Most alcohols and water mix well. As such, the combination is suitable as a mixture. When this fuel mix is fed to the combustion chambers 230 and ignited by spark generators 270, the alcohol portion of the mix burns easily, raising the temperature inside the combustion chambers 230 to over 100° C. in a very short time. Thus, expanded gases from the burnt alcohol will start moving at extreme speeds. Likewise, the water portion of the mix (30%) will be rapidly heated and boiled into steam at 100° C., at which time it also expands and moves at great speeds through the combustion chambers 230 towards exit orifices 240, where the accelerating and expanding gases pass across turbine 300. This generates electrical power from generator 400 used to continue operation of all electrical accessories.

The exiting combustion gases enter an upper gas reaction area 510 formed from converging walls 500 of exhaust section B1. In this section, the exiting gases further expand and develop high pressure and temperature, ever continuously expanding and rushing toward automatic adjustable gas entry point 520 where the exiting gases then enter a lower gas reaction area 620 formed by diverging walls 600 of exhaust section C1. In lower gas reaction area 620, the exiting gases further increase in pressure and temperature and enter the first stage of a multiple stage compound exhaust system 700 provided at section D1 of the exhaust system. As shown, there are three stages formed by stage sections 710, 720 and 730. Continued flow paths of the exiting gases develop multiple action and reaction forces, acting to further extract kinetic force from the gases and further providing thrust force to propel the jet and associated craft upward. A suitable exemplary multiple stage compound exhaust system is the 3-stage compound exhaust system disclosed in U.S. Pat. No. 6,367,739, the subject matter of which is hereby incorporated herein by reference in its entirety. However, advantages can be achieved by as few as two stages and as many as 10 or more, the higher the number the higher the efficiency.

The compound exhaust system works by careful control of the kinetic forces acting on the exhaust gases. The gas molecules traveling from the combustion chambers into the first stage of the compound exhaust system at a high speed become abruptly stopped at the top surface of the first stage of the exhaust, where it is known from conservation of energy that the kinetic energy becomes transferred into heat. At this time, the orderly motion of the high speed molecules becomes chaotic, and in an instant the molecules again regroup and move upward, pushing the incoming gases up by reactionary forces. Upon being pushed back by stronger gases coming from the exhaust, the gas molecules further regroup and exit toward the high speed jet nozzles of the exhaust system into the second stage of the exhaust system, where the movement pattern is repeated until the gases reach the third stage where the movement is repeated a third time until the gases finally exit the exhaust chamber.

Upon exiting from compound exhaust system 700, exiting combustion gases are received by thrust vector nozzle 800, which can be suitably controlled to direct the exiting gases in a desired thrust vector that may be other than in axial alignment with the exhaust system. Owing to the sealed intake structure, such a jet engine will operate with reduced sound level than that typically found on conventional jet engines that include a large open-mouth intake system. If additional sound reducing properties are desired, a conventional sound cancellation device 900 can be installed to the end of the exhaust system as known in the art.

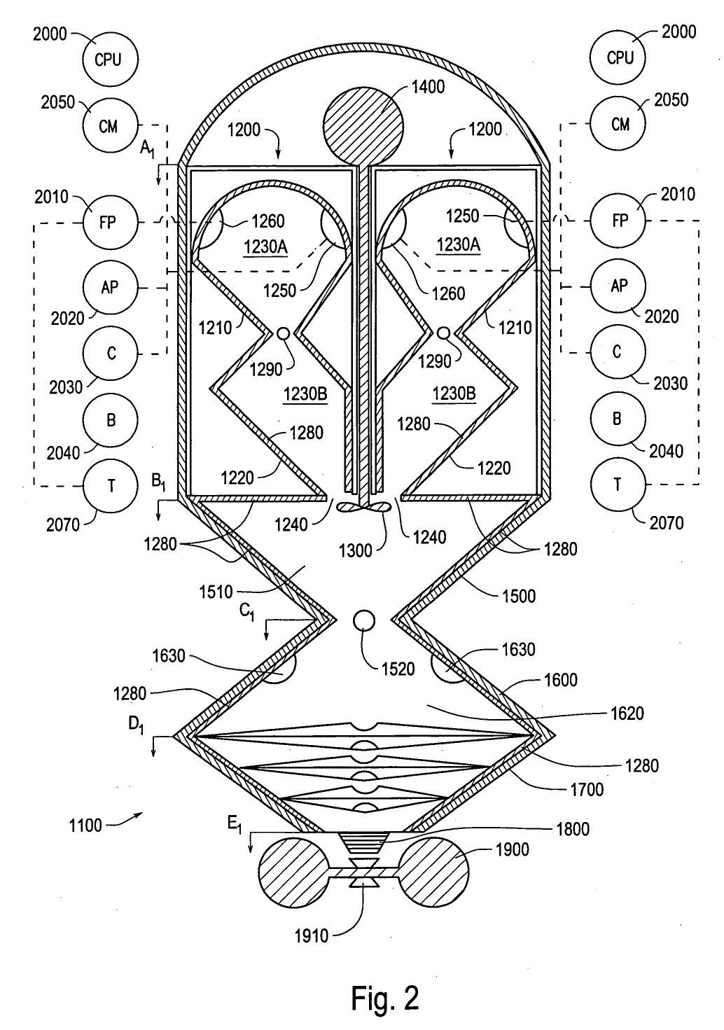

Another exemplary embodiment of a quantum jet turbine system is illustrated in FIG. 2. This embodiment preferably operates using a mixture of air and water as a power generating propulsion source. This is a much more environmentally friendly solution than that of FIG. 1. Quantum jet turbine system 1100 includes multiple separate quantum jet engines 1200 housed within a single, common sealed exhaust system, preferably made up of sections A1, B1, C1, D1 and E1. Each quantum jet engine 1200 is housed in section A1 of the exhaust system, and includes an outer casing 1210 having a sealed, airtight top and converging lower walls 1220 defining upper and lower combustion chambers 1230A and 1230B therebetween. Each quantum jet engine 1200 further includes a combustion exit orifice 1240.

Within each upper combustion chamber 1230A are located one or more air nozzles 1250. Air nozzles 1250 are operably connected to an electric air compressor 2030 through a suitable airtight, sealed feed line (unshown). Flow from the compressor 2030 to air nozzles 1250 may be enhanced by air pump 2020 provided in-line between compressor 2030 and air nozzles 1250. Also, the air may be fed through chilling mechanisms 2050 prior to reaching air nozzles 250. Electric air compressors 2030 may receive air/oxygen from a suitable remote source, such as an on-board storage tank or an unshown air intake, which can be in communication with the atmosphere but provided remote from the jet engines 1200. Suitable filtering may be provided at or between the intake and electric compressors 2030 to prevent large objects from entering the system.

Also within each combustion chamber 1230A are located one or more fluid nozzles 1260 for providing water to the combustion chamber. Fluid nozzles 1260 are operably connected to an on-board fluid (water) storage tank 2070 through a suitable airtight, sealed feedline (unshown). Flow from the tank 2070 may be enhanced by a fluid pump 2010 provided in-line between the tank 2070 and fluid nozzles 1260.

Because a combustible fuel is not used in this embodiment, there is no spark generator. In its place are provided one or more heating elements 1280 wrapped around inner walls 1210 and 1220 of the combustion chambers and extending downward to preferably cover remaining interior walls of the exhaust system. Insulators may be provided around the exhaust system housing to retain heat inside the exhaust system, keeping the remainder of the craft fuselage unaffected by the heat.

However, as in the previous embodiment, there is a generator 1400 operably connected through a shaft or other structure to a turbine 1300 having one or more turbine blades placed in the exit path of the combustion exit orifices 1240 as shown. Upon generation of expansion gases exiting the various jet engines 1200 through orifices 1240, rotation of turbine 1300 will occur, which can be used with known and conventional structure to generate electrical energy from generator 1400. As in the previous embodiment, electrical output from generator 1400 may be electrically connected to batteries 2040 for recharging purposes and/or may be used to power various auxiliary devices, such as processor 2000, fluid pump 2010, air pump 2020, electric air compressors 2030, cooling mechanisms 2050 or other devices associated with the engine or craft.

During operation, quantum jet turbine engines 1200 are started by using either pure distilled water or superchilled air individually or jointly as a propulsion source. Both shown quantum jet engines 1200 will have their upper combustion chambers 1230A isolated from the lower chambers 1230B by locking of gas valve locking devices 1290 provided between the upper and lower combustion chambers. At this time, batteries 2040 are activated to raise the temperature of heating elements 1280 to between 200-400° C. or more preferably, in the range of 1000°-3500° C., most preferably between 1000°-2500° C.

An exemplary heating element 1280 would be an oscillating circuit. This operates by wrapping a coil of wire subjected to a rapidly alternating current around a piece of metal. This induces eddy currents in the metal by induction. The effect is closely related to induced currents discovered by Michael Faraday. The advantage to such a heating element source is that no flame is present and the metal may be treated in a vacuum or in an atmosphere of gas, such as hydrogen. Such heating is not possible with a combustible heat source such as a flame because of either a lack of oxygen or an explosive environment. It would also be possible to provide heating elements 1280 using dielectric heating. With such, when a sheet of non-conducting material is placed between plates of a condenser to which a high frequency oscillator is connected, the rapidly changing electric field in this region causes internal heating of the conductor (such as H₂O) and the non-conductor (such as chilled air).

To achieve the higher heat range, preferred heating elements 1280 are of the high heat generator type, which are known and have a capacity to heat a confined vessel from a minimum of 1000° C. up to about 3500° C. The materials of the engines and exhaust are suitably chosen to withstand such heat.

The compressors and chilling mechanism prepare the air and pressurize the water while the engines are preheated. Once preheated, the high pressure fluid nozzles 1260 will then be opened to spray a fine mist of high pressure water inside both upper combustion chambers 1230A while the automatic gas locking device 1290 is opened at an appropriate time. At almost the same time, superchilled air is supplied to the combustion chambers. When the system is ready, the initial high pressure steam from within the upper combustion chambers 1230A will travel at extreme speeds toward the lower combustion chambers 1230B and further expand and continue its downward path through exit orifices 1240 past turbine 1300. At this time, processor 2000 can cut off battery current and simultaneously activate the main electric air compressors 2030, while simultaneously activating the fluid and air pumps and other electrical devices by way of current flowing from generator 1400, which is suitably sized to power all required electrical devices.

After passing turbine 1300, the exhaust gases pass through upper gas expansion area 1510 defined by converging walls 1500 of exhaust section B1. In this section, the exiting gases further expand and develop high pressure and temperature ever continuously expanding and rushing toward automatic adjustable gas entry point 1520 where the exiting gases then enter a lower gas reaction area 1620, formed by diverging walls 1600 of exhaust section C1. In lower gas reaction area 1620, the exiting gases further increase in pressure and temperature and enter the first stage of a multiple stage compound exhaust system 1700 provided at section D1 of the exhaust system. As shown, there are three stages. Continued flow paths of the exiting gases develop multiple action and reaction forces, acting to further extract kinetic force from the gases and further providing thrust force to propel the jet and associated craft upward. As in the previous example, a suitable exemplary multiple stage compound exhaust system is the 3-stage compound exhaust system disclosed in U.S. Pat. No. 6,367,739, the subject matter of which is hereby incorporated herein by reference in its entirety.

Upon exiting from compound exhaust system 1700, exiting combustion gases are received by thrust vector nozzle 1800, which can be suitably controlled to direct the exiting gases in a desired thrust vector that may be other than in axial alignment with the exhaust system. If additional power generation is needed, additional generators 1900 having turbine blades 1910 may be provided at other positions along the gas flow path, such as after the thrust vector nozzle 1800 as shown in FIG. 2.

As an alternative to water as a primary propulsion source, the inventive quantum jet turbine system can use superchilled air as a primary source of power. In such an application, it will be provided with large, efficient chilling or cooling mechanisms 2050 augmented by efficient air compressors 2030 so as to draw in a large volume of air from the atmosphere, such as through a remotely located intake port.

In operation, this embodiment will be activated by switching on the heating mechanisms 1280 and the secondary chilling/cooling mechanisms 2050 using battery power from batteries 2040. When a desired temperature of, for example, 200-400° C. or higher is reached, high pressure superchilled air is pumped into both upper combustion chambers 1230A by air pumps 2020, and when a suitable pressure builds up, the automatic adjustable locking devices 1290 will automatically open. This allows the much expanded air to enter the lower combustion chambers 1230B, where the air further expands while passing by turbine 1300, which activates main generator 1400. At this time, processor 2000 can shut off battery supply and run accessories from generator power generated by rotation of the turbine 1300. Heat inside the system can be maintained by use of insulation installed around the exhaust housing.

When the system is at work and the required heat is maintained, additional high pressure chilled air can be pumped into the lower gas expansion area 1620 by cold air nozzles 1630 to further increase the speed of the highly accelerated gases, which expand since superchilled air expands when heated. As in the previous embodiment, the expanding gases can pass through the compound multiple stage exhaust system to extract additional kinetic energy from the exiting gases before the gases finally leave the exhaust system. Thus, by providing an extended exhaust system and path length, the efficiency of kinetic energy usage can be increased.

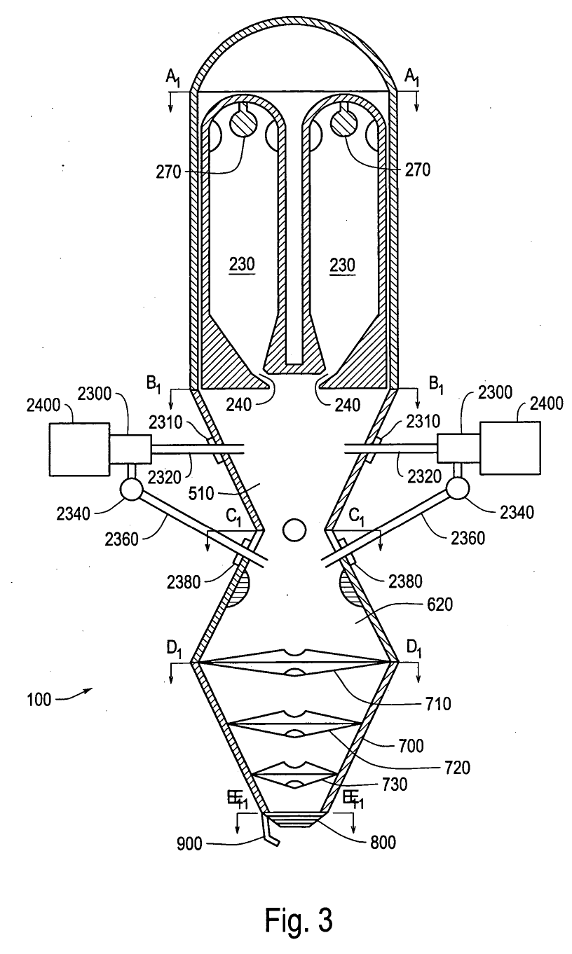

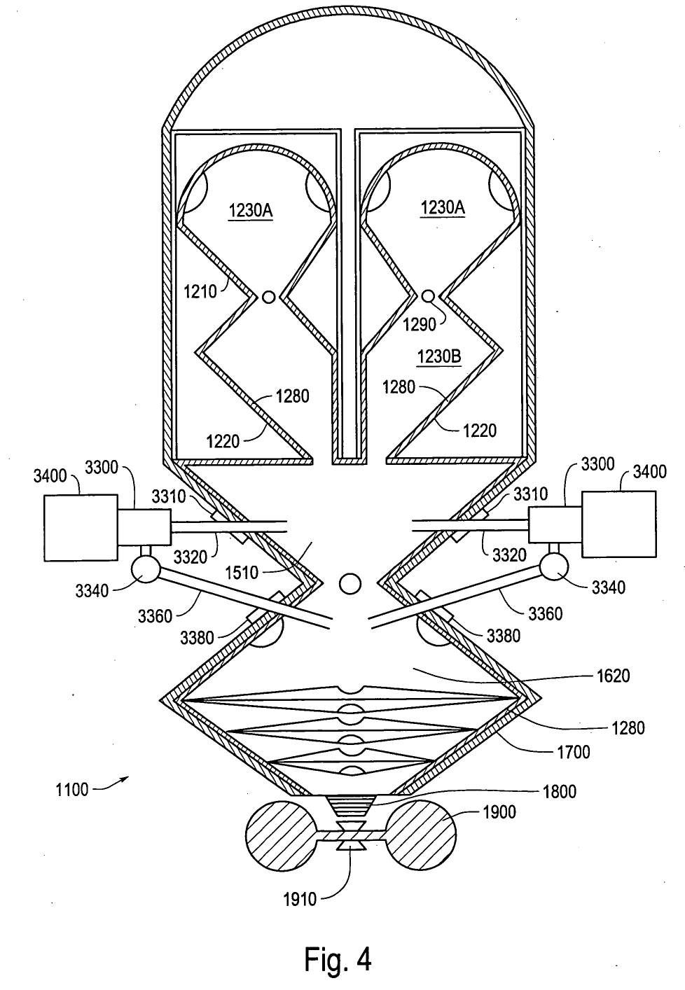

Although internally provided generators are provided in FIGS. 1-2, externally provided generators can also be provided, as illustrated in the alternative embodiments of FIGS. 3-4. In particular, FIG. 3 is otherwise the same as that of FIG. 1, but substitutes external turbines 2300 for the internal turbine 300 of FIG. 1, and substitutes external generators 2400 for internal generator 400 of FIG. 1. Turbines 2300 receive a supply of high speed gas from within upper gas expansion area 510 through valves 2310 and incoming flow lines 2320. The entering gases rotate the blades within the turbine to generate energy from generators 2400 coupled to respective turbines 2300. The speeding gases may then be pumped by pump 2340 through exit lines 2360 to the lower gas reaction area 620 through valves 2380. Similarly, FIG. 4 is otherwise the same as that of FIG. 2, but substitutes external turbines 3300 for the internal turbine 1300 of FIG. 2, and substitutes external generators 3400 for internal generator 1400 of FIG. 2. Turbines 3300 receive a supply of high speed gas from within upper gas expansion area 1510 through valves 3310 and incoming flow lines 3320. The entering gases rotate the blades within the turbine to generate energy from generators 3400 coupled to respective turbines 3300. The speeding gases may then be pumped by pumps 3340 through exit lines 3360 to the lower gas reaction area 1620 through valves 3380.

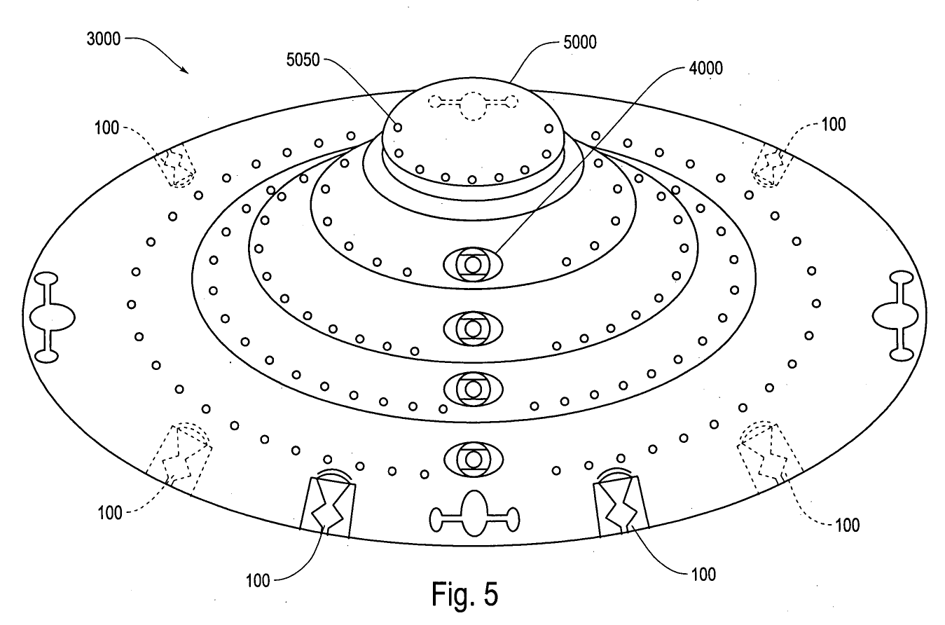

As mentioned previously, the inventive quantum jet turbine propulsion system is well suited to most any type of vehicle. However, it is particularly suited for application to a spacecraft, such as the craft illustrated in FIG. 5. This craft 3000 includes various quantum jet turbine propulsion systems 100 spaced around the craft, and may further include other propulsion systems, such as high frequency oscillators 4000 shown below cabin 5000 having windows 5050. Additional details of such an exemplary craft can be found in Applicant's incorporated co-pending U.S. patent application Ser. No. ______ (Attorney Docket No. 104148).

As mentioned earlier, the quantum jet turbine engine system preferably has two or more smaller jet engines within a single, common exhaust. This has been found to have improved kinetic energy by using the same amount of fuel, which travels at higher velocities within the smaller jet engines. For example, knowing that kinetic energy KE= 1/2MV², where M is mass and V is velocity, it can be shown how multiple jet engines can achieved increases in both efficiency and output.

In a mono jet configuration, assuming a 100 lb. mass of high speed gases in the combustion chamber and a gas velocity of 32 feet/second, KE=½MV²=100/2×32²=51,200 foot pounds of work. In a dual jet configuration, the 100 lb. mass can be equally distributed between the two smaller jets, which operate at a higher gas velocity of 64 feet/second. KE=1/2MV²=50/2×64²=102,400 foot pounds of work for each engine, for a total of 204,800 foot pounds. Similarly, in a tri engine configuration, which could operate at a higher gas velocity of 128 feet/second, KE=1/2MV²=33.3/2×128²=272,794 foot pounds of work for each engine, for a total of 818,382 foot pounds. For a quad jet configuration, which would operate at yet a higher velocity because of its smaller jet sizes, KE=½MV²=25/2×256²=819,200 foot pounds of work for each engine, for a total of 3,276,800 foot pounds.

When water is used as a propulsion source, steam serves as the exhaust gas. If the exiting and expanding high pressure steam (H₂O) is cooled in the exhaust chamber while keeping pressure high, the steam can be reverted back to a liquid form, where it can be pumped out and returned to the fuel tank for reuse.

While specific aspects of the invention have been described with respect to preferred embodiments of the invention, these are not intended to be limiting. Various modifications can be made without departing from the scope of the appended claims.

1. A quantum jet turbine propulsion system for a land, sea, air or space craft, comprising:
a plurality of individual quantum jet turbine engines, each comprising a generally sealed housing that encompasses all but an exit orifice of the engine and includes inner walls that define at least one combustion chamber, the housing including air and/or fluid nozzles for admittance of a propulsion source into the at least one combustion chamber;
a generally sealed common exhaust system having a housing that completely encompasses the plurality of individual quantum jet turbine engines, the exhaust housing extending below quantum jet engine housings to define at least one common gas expansion chamber below the individual exit orifices of the plurality of individual quantum jet turbine engines; and
a remote propulsion source delivery mechanism located external from the quantum jet turbine housings,
wherein gases from the propulsion source are expanded in each of the plurality of quantum jet turbine engine combustion chambers and expelled through respective exit orifices and commonly into at least a first gas expansion chamber of the common exhaust system where the gases are combined and exit the exhaust system.

2. The quantum jet turbine propulsion system according to claim 1, wherein the propulsion source includes water.

3. The quantum jet turbine propulsion system according to claim 1, wherein the propulsion source includes air.

4. The quantum jet turbine propulsion system according to claim 1, wherein the propulsion source includes a combustible fuel.

5. The quantum jet turbine propulsion system according to claim 4, wherein the combustible fuel is a mixture including a percentage of water, the combustible fuel being admixed with a source of air or oxygen.

6. The quantum jet turbine propulsion system according to claim 1, wherein at least two quantum jet engines are symmetrically arranged within the interior of the exhaust housing.

7. The quantum jet turbine propulsion system according to claim 1, wherein a compound exhaust system is provided downstream from the at least one gas expansion chamber.

8. The quantum jet turbine propulsion system according to claim 7, wherein a second gas expansion chamber is provided between the first gas expansion chamber and the compound exhaust system, the first gas expansion chamber being defined by converging walls whereas the second gas expansion chamber is defined by diverging walls.

9. The quantum jet turbine propulsion system according to claim 8, wherein a chilled air nozzle is provided in the second gas expansion chamber.

10. The quantum jet turbine propulsion system according to claim 7, wherein the compound exhaust system induces an involute flow path to the exiting gases.

11. The quantum jet turbine propulsion system according to claim 1, further comprising a spark generator within the combustion chamber of each quantum jet turbine engine.

12. The quantum jet turbine propulsion system according to claim 1, further comprising a heating element on at least an inner surface of each combustion chamber.

13. The quantum jet turbine propulsion system according to claim 12, wherein the heating element is a dielectric heating element.

14. The quantum jet turbine propulsion system according to claim 12, wherein the heating element is an oscillating circuit.

15. The quantum jet turbine propulsion system according to claim 12, wherein the heating element is a high heat generator that heats the combustion chamber to at least 1000° C.

16. The quantum jet turbine propulsion system according to claim 12, wherein the heating element extends beyond the combustion chambers into at least the at least one gas expansion chamber.

17. A quantum jet turbine propulsion system for a land, sea, air or space craft, comprising:
a plurality of individual quantum jet turbine engines, each comprising a generally sealed housing that encompasses all but an exit orifice of the engine and includes inner walls that define at least one combustion chamber, the housing including air and/or fluid nozzles for admittance of a propulsion source into the at least one combustion chamber;
a generally sealed common exhaust system having a housing that completely encompasses the plurality of individual quantum jet turbine engines, the exhaust housing extending below the quantum jet engine housings to define at least one common gas expansion chamber below individual exit orifices of the plurality of individual quantum jet turbine engines;
a turbine shaft having a blade positioned in fluid communication with one or more of the exit orifices to receive rotational forces therefrom;
a generator operatively coupled to the turbine shaft blade to generate electrical power from rotation of the turbine shaft blade; and
a remote propulsion source delivery mechanism located external from the quantum jet turbine housings,
wherein gases from the propulsion source are expanded in each of the plurality of quantum jet turbine engine combustion chambers and expelled through respective exit orifices and commonly into at least a first gas expansion chamber of the common exhaust system where the gases are combined and exit the exhaust system.

18. The quantum jet turbine propulsion system according to claim 17, wherein a multiple stage compound exhaust system is provided downstream from the at least one gas expansion chamber.

19. A quantum jet turbine propulsion system for a land, sea, air or space craft, comprising:
a plurality of individual quantum jet turbine engines, each comprising a generally sealed housing that encompasses all but an exit orifice of the engine and includes inner walls that define at least one combustion chamber, the housing including air and/or fluid nozzles for admittance of a propulsion source into the at least one combustion chamber;
a generally sealed common exhaust system having a housing that completely encompasses the plurality of individual quantum jet turbine engines, the exhaust housing extending below the quantum jet engine housings to define at least one common gas expansion chamber below individual exit orifices of the plurality of individual quantum jet turbine engines;
a turbine shaft having a blade positioned in fluid communication with one or more of the exit orifices to receive rotational forces therefrom;
a generator operatively coupled to the turbine shaft blade to generate electrical power from rotation of the turbine shaft blade;
a remote propulsion source delivery mechanism located external from the quantum jet turbine housings;
a multiple stage compound exhaust system provided downstream from the at least one gas expansion chamber; and
a second gas expansion chamber provided between the first gas expansion chamber and the compound exhaust system, the first gas expansion chamber being defined by converging walls whereas the second gas expansion chamber is defined by diverging walls,
wherein gases from the propulsion source are expanded in each of the plurality of quantum jet turbine engine combustion chambers and expelled through respective exit orifices and commonly into the first gas expansion chamber of the common exhaust system where the gases are combined and exit the exhaust system.

20. A quantum jet turbine propulsion system for a land, sea, air or space craft, comprising:
a plurality of individual quantum jet turbine engines, each comprising a generally sealed housing that encompasses all but an exit orifice of the engine and includes inner walls that define at least one combustion chamber, the housing including air and/or fluid nozzles for admittance of a propulsion source including water into the at least one combustion chamber;
a generally sealed common exhaust system having a housing that completely encompasses the plurality of individual quantum jet turbine engines, the exhaust housing extending below the quantum jet engine housings to define at least one common gas expansion chamber below individual exit orifices of the plurality of individual quantum jet turbine engines;
a remote propulsion source delivery mechanism located external from the quantum jet turbine housings;
a heating element on at least an inner surface of each combustion chamber to heat the water to a suitable propulsion generating temperature;
a multiple stage compound exhaust system provided downstream from the at least one gas expansion chamber; and
a second gas expansion chamber provided between the first gas expansion chamber and the compound exhaust system, the first gas expansion chamber being defined by converging walls whereas the second gas expansion chamber is defined by diverging walls,
wherein gases from the propulsion source are expanded in each of the plurality of quantum jet turbine engine combustion chambers and expelled through respective exit orifices and commonly into the first gas expansion chamber of the common exhaust system where the gases are combined and exit the exhaust system.
